(19) United States
(12) Patent Application Publication
(10) Pub. No.: US 2021/0165201 A1
(43) Pub. Date: Jun. 3, 2021

(54) MICROSCOPE OBJECTIVE LENS AND MICROSCOPE

(71) Applicant: OLYMPUS CORPORATION, Tokyo (JP)

(72) Inventor: Kanto MIYAZAKI, Tokyo (JP)

(73) Assignee: OLYMPUS CORPORATION, Tokyo (JP)

(21) Appl. No.: 17/154,141

(22) Filed: Jan. 21, 2021

Related U.S. Application Data
(63) Continuation of application No. PCT/JP2018/027952, filed on Jul. 25, 2018.

(51) Int. Cl. G02B 21/02; G02B 21/00; G02B 27/00

(52) U.S. Cl. CPC G02B 21/02; G02B 27/0025; G02B 21/0076; G02B 21/0032

(57) ABSTRACT

A microscope objective lens includes: in order from an object side, a first lens group having a negative refractive power; a second lens group having a positive refractive power; a third lens group having a negative refractive power; and a phase plate arranged nearer to an image side than the lens of the third lens group arranged nearest the image side is, wherein a surface of the first lens group nearest the object side is a concave surface facing toward the object, and a specified conditional expression is satisfied.

### CROSS-REFERENCE TO RELATED APPLICATIONS

This is a continuation of International Application PCT/JP2018/027952, with an international filing date of Jul. 25, 2018, which is hereby incorporated by reference herein in its entirety.

### TECHNICAL FIELD

The present invention relates to a microscope objective lens and a microscope.

### BACKGROUND ART

There is a known objective lens for phase difference microscopy that has a phase plate arranged at the pupil position of the objective lens (for example, refer to PTL 1).

### CITATION LIST

### Patent Literature

{PTL 1} Japanese Unexamined Patent Application Publication No. Hei 9-197284

### SUMMARY OF INVENTION

An aspect of the present invention is directed to a microscope objective lens including: in order from an object side, a first lens group having a negative refractive power; a second lens group having a positive refractive power; a third lens group having a negative refractive power; and a phase plate arranged nearer to an image side than a lens of the third lens group arranged nearest the image side is. A surface of the first lens group nearest the object side is a concave surface facing toward the object. The microscope objective lens satisfies the following conditional expression:

−3.8≤f1/f≤−2.0

Here, f is the local length of the microscope objective lens, and f1 is the focal length of the first lens group.

### BRIEF DESCRIPTION OF DRAWINGS

FIG. 1 is a diagram schematically illustrating a microscope according to an embodiment of the present invention.

FIG. 2 is a diagram illustrating a first example of an objective lens of the microscope in FIG. 1.

FIG. 3 is a diagram illustrating the shape of a coded aperture arranged at the pupil position of the objective lens in FIG. 2.

FIG. 4 FIG. 4 is a diagram illustrating spherical aberration of the objective lens in FIG. 2.

FIG. 5 is a diagram illustrating astigmatism of the objective lens in FIG. 2.

FIG. 6 is a diagram illustrating distortion of the objective lens in FIG. 2.

FIG. 7 is a diagram illustrating a second example of an objective lens of the microscope in FIG. 1.

FIG. 8 is a diagram illustrating spherical aberration of the objective lens in FIG. 7.

FIG. 9 is a diagram illustrating astigmatism of the objective lens in FIG. 7.

FIG. 10 is a diagram illustrating distortion of the objective lens in FIG. 7.

FIG. 11 is a diagram illustrating a third example of an objective lens of the microscope in FIG. 1.

FIG. 12 is a diagram illustrating spherical aberration of the objective lens in FIG. 11.

FIG. 13 is a diagram illustrating astigmatism of the objective lens in FIG. 11.

FIG. 14 is a diagram illustrating distortion of the objective lens in FIG. 11.

### DESCRIPTION OF EMBODIMENTS

An objective lens 4 and a microscope 1 according to an embodiment of the present invention will be described hereafter while referring to the drawings.

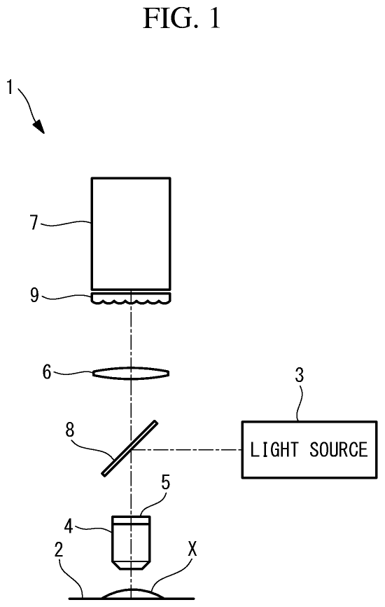

As illustrated in FIG. 1, the microscope 1 according to this embodiment includes: a stage 2 on which a sample (object) X is placed; the objective lens (microscope objective lens) 4 that irradiates the sample X placed on the stage 2 with excitation light from a light source 3 and collects fluorescence generated by the sample X; an image-forming lens 6 that images the fluorescence collected by the objective lens 4; and an image-capturing element 7 that subjects the formed image of the sample X to electro-optical conversion and captures a fluorescence image.

The light source 3 emits excitation light including ultraviolet light.

In the figure, symbol 8 denotes a dichroic mirror having transmittance characteristics such that the excitation light is deflected and fluorescence is transmitted therethrough and symbol 9 denotes a microlens array arranged on an image-capturing plane of the image-capturing element 7 between the image-forming lens 6 and the image-capturing element 7.

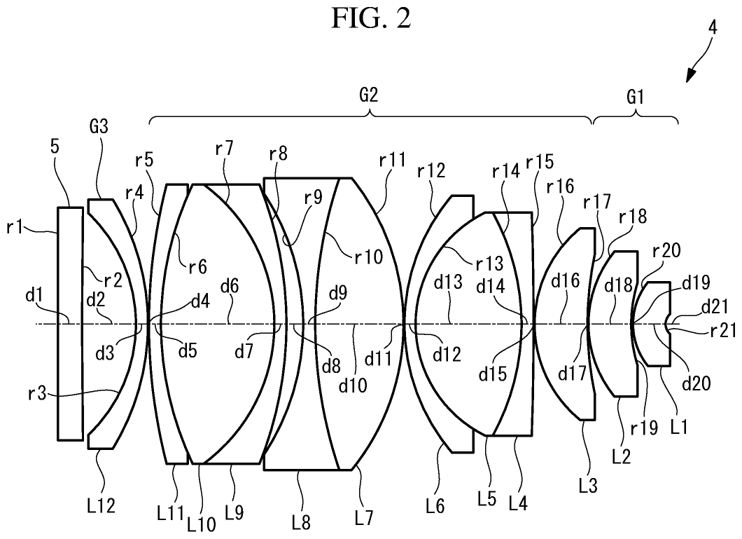

As illustrated in FIG. 2, the objective lens 4 according to this embodiment includes, in order from the sample X side, a first lens group G1 having a negative refractive power, a second lens group G2 having a positive refractive power, a third lens group G3 having a negative refractive power, and a phase plate 5.

The phase plate 5 is a coded aperture and is formed of a glass material that satisfies the following conditional expressions:

1.43≤nd≤1.61 (1)

62≤νd≤95 (2)

Here, nd is the refractive index at the d-line, and νd is the Abbe number at the d-line.

The objective lens 4 of this embodiment satisfies the following conditional expressions:

−3.8≤f1/f≤−2.0 (3)

−5.0≤f3/f≤−2.3 (4)

Here,

f: focal length of objective lens 4,

f1: focal length of first lens group G1, and

f3: focal length of third lens group G3.

The objective lens 4 is a telecentric lens on the sample X side and the phase plate 5 is arranged at a position where a principle light beam intersects the optical axis, i.e., at the pupil position of the objective lens 4.

The operation of the thus-configured objective lens 4 and microscope 1 according to this embodiment will be described below.

To acquire a three-dimensional fluorescence image of the sample X using the microscope 1 according to this embodiment, the sample X is placed on the stage 2 and the objective lens 4 is arranged above the sample X.

When the excitation light is generated from the light source 3, the excitation light is deflected at 90° by the dichroic mirror 8 and enters the objective lens 4, and the objective lens 4 then collects and radiates the excitation light onto the sample X. A fluorescent material contained in the sample X is excited, and fluorescence is generated at the position at which the excitation light is radiated onto the sample X and part of the fluorescence is incident on the objective lens 4.

The fluorescence incident on the objective lens 4 is converted into substantially parallel light by the objective lens 4, and the fluorescence passes through the phase plate 5 arranged at the pupil position of the objective lens 4. Then, the fluorescence, which has been converted into substantially parallel light by the objective lens 4, passes through the dichroic mirror 8, is collected by the image-forming lens 6, passes through the microlens array 9, and is captured as an image by the image-capturing element 7.

Information regarding the direction of constraint of the fluorescence can be acquired at the same time as the fluorescence image by capturing the fluorescence as an image using the image-capturing element 7 after the fluorescence has passed through the microlens array 9. This is a so-called light-field technique. The microscope 1 according to this embodiment has an advantage in that the microscope 1 can obtain three-dimensional information of the sample X in a short period of time using the light-field technique.

In addition, according to this embodiment, the depth of the fluorescence image is increased by the phase plate 5 arranged at the pupil position of the objective lens 4, and therefore there is an advantage that the light-field technique can be complemented and three-dimensional information of the entire fluorescence image including focal position can be obtained by complementing the light field technique.

In this case, in this embodiment, since a glass material that satisfies conditional expressions (1) and (2) is used as the material of the coded aperture, i.e., the phase plate 5, the generation of autofluorescence can be suppressed even when excitation light including ultraviolet light is radiated. Therefore, there is an advantage that autofluorescence can be prevented from being included as stray light in the fluorescence from the sample X, and a clear three-dimensional fluorescence image of the sample X can be acquired.

In addition, according to the objective lens 4 of this embodiment, since the phase plate 5 is arranged outside the objective lens 4, i.e., nearer the image side than the lens L12 is, which is the lens nearest the image side, a space in which to arrange an adjustment mechanism (not illustrated in the drawings) can be secured and there is an advantage that precise positional adjustment of the phase plate 5 can be readily performed.

In addition, the microscope 1 according to this embodiment has an advantage that it is possible to adjust shifting of the phase plate 5 in Z-axis directions along the optical axis, along X-axis directions perpendicular to the Z axis, and along Y-axis directions perpendicular to the Z axis and X axis and to adjust a rotational angle of the phase plate 5 around the Z axis by arranging an adjustment mechanism in the space secured for arrangement of the adjustment mechanism of the microscope 1.

Therefore, the objective lens 4 according to this embodiment satisfies conditional expression (3).

In other words, below the lower limit of conditional expression (3), there is a problem that the refractive power of the first lens group G1 is small, and the principal point cannot be sufficiently moved toward the image side, and above the upper limit of conditional expression (3), there is a problem that the refractive power of the first lens group G1 is too high, aberration balance is degraded, and imaging performance deteriorates.

Therefore, by satisfying conditional expression (3), there is an advantage in that excellent imaging performance can be achieved while arranging the phase plate 5 at a pupil position located outside the objective lens 4 by sufficiently moving the principal point toward the image side.

Furthermore, the objective lens 4 according to this embodiment has an advantage that a sufficient working distance can be ensured by satisfying conditional expression (4).

In other words, below the lower limit of conditional expression (4), there is a problem that the refractive power of the third lens group G3 is small and it becomes difficult to secure the operational distance, and above the upper limit of conditional expression (4), there is a problem that the refractive power of the third lens group G3 is too high, aberration balance is degraded, and imaging performance deteriorates.

Therefore, there is an advantage that excellent imaging performance can be achieved while ensuring a sufficient working distance when conditional expression (4) is satisfied.

### Example 1

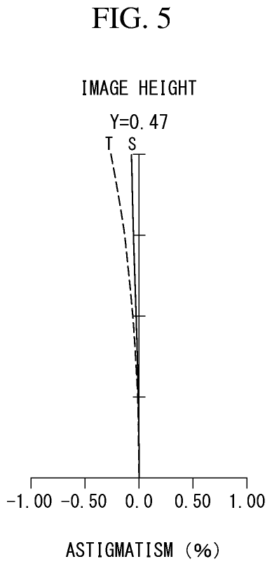

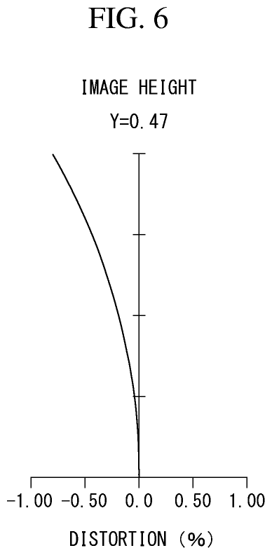

Next, a first example of the objective lens 4 according to this embodiment will be described while referring to FIGS. 2 to 6 and the lens data given below.

In the objective lens 4 of this example, the first lens group G1 includes, in order from the sample X side, a meniscus lens L1 having a concave surface facing toward the sample X and a meniscus lens L2 having a concave surface facing toward the sample X. The second lens group G2 includes, in order from the sample X side, a meniscus lens L3 having a concave surface facing toward the sample X, a cemented lens including a meniscus lens L4 and a biconvex lens L5, a meniscus lens L6 having a concave surface facing toward the sample X, a cemented lens including a biconvex lens L7 and a biconcave lens L8, and a cemented lens including a meniscus lens L9 having a convex surface facing toward the sample X, a biconvex lens L10, and a meniscus lens L11. The third lens group G3 includes a meniscus lens (lens) L12 having a convex surface facing toward the sample X. The phase plate 5 is composed of flat plate glass.

| Surface number | r | d | nd | νd |
|---|---|---|---|---|
| 1 | ∞ | 2.0000 | 1.4585 | 67.80 |
| 2 | ∞ | 4.3717 | | |
| 3 | −12.5000 | 0.9500 | 1.6541 | 39.68 |
| 4 | −19.4199 | 0.1000 | | |
| 5 | 44.9912 | 0.9500 | 1.5710 | 50.80 |
| 6 | 25.5554 | 9.2504 | 1.8414 | 24.56 |
| 7 | −13.8724 | 0.9500 | 1.7995 | 42.22 |
| 8 | −30.5511 | 1.4287 | | |
| 9 | −19.2131 | 0.9500 | 1.8081 | 22.76 |
| 10 | 38.0112 | 7.1402 | 1.5952 | 67.74 |
| 11 | −18.7030 | 0.1000 | | |
| 12 | 16.1275 | 0.9500 | 1.8052 | 25.43 |
| 13 | 10.1159 | 8.5916 | 1.4970 | 81.55 |
| 14 | −18.1518 | 0.9500 | 1.8052 | 25.43 |
| 15 | −273.9537 | 0.1000 | | |
| 16 | 10.0242 | 4.3172 | 1.6779 | 55.34 |
| 17 | 27.9305 | 0.1000 | | |
| 18 | 9.2598 | 3.4750 | 1.8040 | 46.58 |
| 19 | 12.5716 | 0.1000 | | |
| 20 | 5.2644 | 2.7024 | 1.8830 | 40.77 |
| 21 | 1.5000 | 0.8001 | 1.3330 | 55.72 |

The focal length of the objective lens 4 is 12.0 mm, and the numerical aperture is 1.0.

In the above lens data, surface number 2 refers to a coded aperture, i.e., the phase plate 5, and the radius of curvature r is given as ∞, but the actual shape would be:

z=1.5×10⁻¹¹(x³+y³) (3).

Here, z is the optical axis direction, x and y are directions that are perpendicular to the optical axis and perpendicular to each other, and units of m are used.

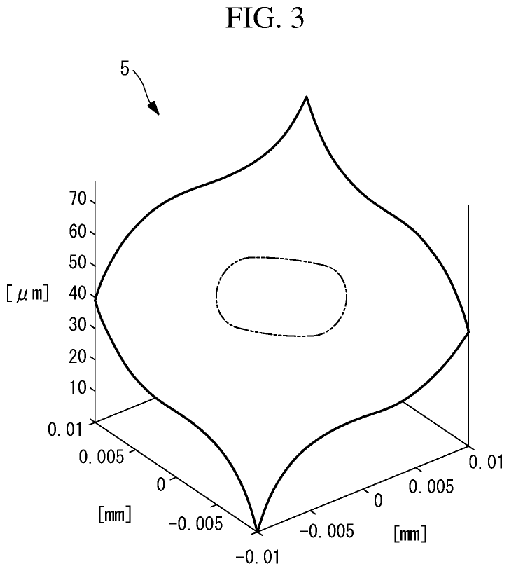

The shape of the phase plate 5 is illustrated in FIG. 3. In the drawing, the area surrounded by a line is the effective diameter area.

The flat plate glass material is synthetic quartz or another glass material that exhibits low auto-fluorescence.

The objective lens 4 is telecentric lens located on the sample X side, and the phase plate 5 is arranged near the pupil position where a principal light beam intersects the optical axis.

According to the lens data, the focal length of the objective lens 4 is f=12.0, the focal length of the first lens group G1 is f1=−32.90, the focal length of the second lens group G2 is f2=−15.43, and the focal length of the third lens group G3 is f3=−57.09.

Therefore, f1/f=−2.74 and f3/f=−4.76 and conditional expressions (3) and (4) are satisfied.

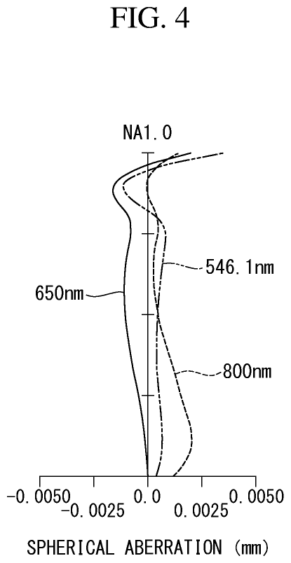

FIGS. 4 to 6 illustrate aberration diagrams. It is clear that aberrations are well corrected.

### Second Example

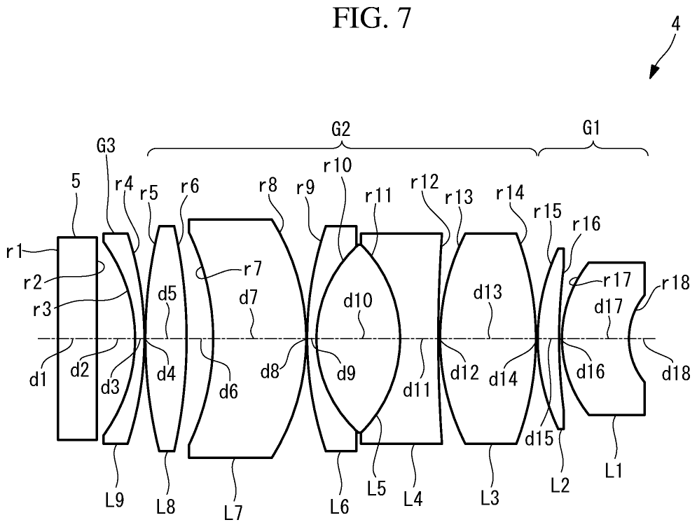

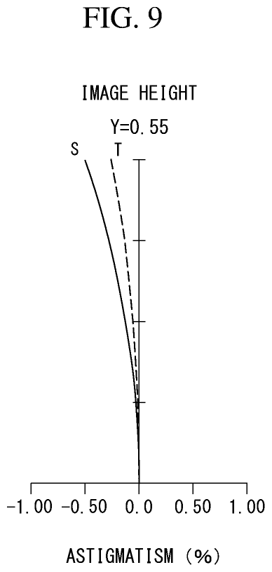

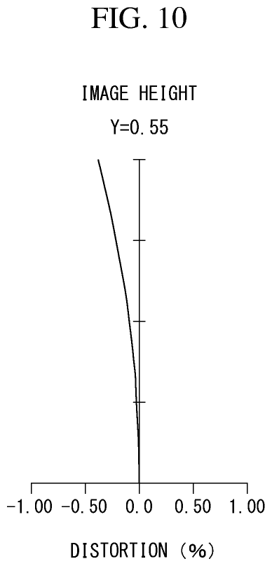

Next, a second example of the objective lens 4 according to this embodiment will be described while referring to FIGS. 7 to 10 and the lens data given below.

In the objective lens 4 of this example, the first lens group G1 includes, from the sample X side, a meniscus lens L1 having a concave surface facing toward sample X. The second lens group G2 includes, in order from the sample X side, a meniscus lens L2 having a concave surface facing toward the sample X, a biconvex lens L3, a cemented lens including a meniscus lens L4 having a concave surface facing toward the sample X, a biconvex lens L5, and a meniscus lens L6, a meniscus lens L7 having a convex surface facing toward the sample X, and a biconvex lens L8. The third lens group G3 includes a meniscus lens (lens) L9 having a convex surface facing toward the sample X. The phase plate 5 is composed of flat plate glass.

| Surface number | r | d | nd | νd |
|---|---|---|---|---|
| 1 | ∞ | 2.0000 | 1.5163 | 64.14 |
| 2 | ∞ | 2.0000 | | |
| 3 | −8.5000 | 0.4600 | 1.5163 | 64.14 |
| 4 | −17.7969 | 0.1000 | | |
| 5 | 25.9886 | 2.1310 | 1.7380 | 32.26 |
| 6 | −26.8723 | 1.3536 | | |
| 7 | −13.3818 | 4.8626 | 1.4970 | 81.55 |
| 8 | −11.6780 | 0.1000 | | |
| 9 | 18.3631 | 0.4600 | 1.6730 | 38.15 |
| 10 | 6.5862 | 4.3664 | 1.4970 | 81.55 |
| 11 | −7.0381 | 1.9931 | 1.6730 | 38.15 |
| 12 | 57.3994 | 0.1173 | | |
| 13 | 12.2679 | 5.0000 | 1.4388 | 94.95 |
| 14 | −14.8618 | 0.1000 | | |
| 15 | 11.1001 | 1.1271 | 1.6779 | 55.34 |
| 16 | 34.2081 | 0.1000 | | |
| 17 | 6.1519 | 3.5138 | 1.8830 | 40.77 |
| 18 | 3.5000 | 2.5005 | | |

The focal length of the objective lens 4 is 9.0 mm, and the numerical aperture is 0.5.

In the above lens data, surface number 2 refers to a coded aperture, i.e., the phase plate 5, and the radius of curvature r is given as ∞, but the actual shape would be:

z=2.29×10⁻¹¹(x³+y³) (3).

The flat plate glass material is S-BSL7 or another glass material that exhibits low auto-fluorescence.

According to the lens data, the focal length of the objective lens 4 is f=9.0, the focal length of the first lens group G1 is f1=−24.27, the focal length of the second lens group G2 is f2=11.58, and the focal length of the third lens group G3 is f3=−31.94.

Therefore, f1/f=−2.70 and f3/f=−3.55, and conditional expressions (3) and (4) are satisfied.

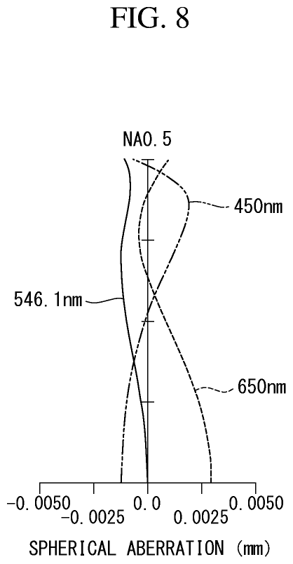

FIGS. 8 to 10 illustrate aberration diagrams. It is clear that aberrations are well corrected.

### Third Example

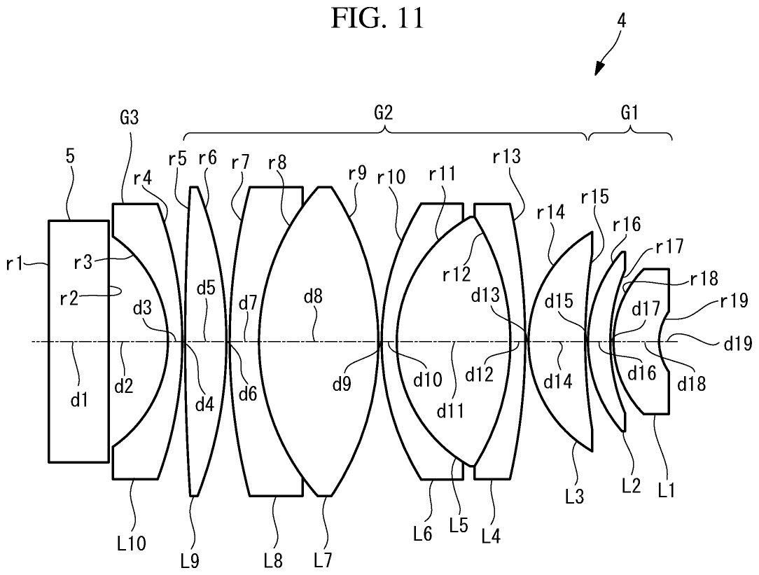

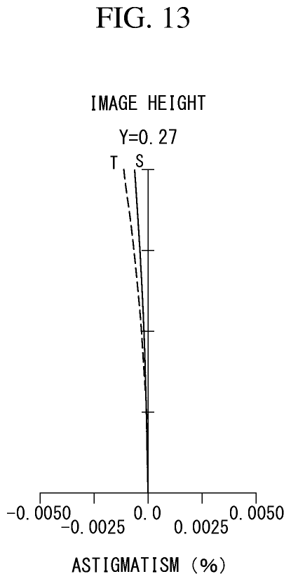

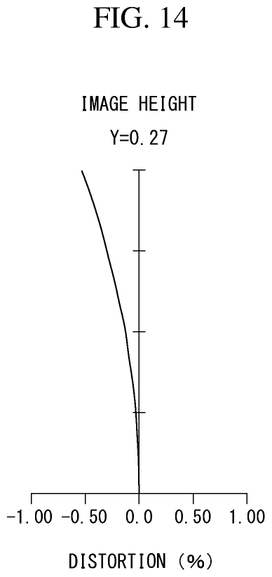

Next, a third example of the objective lens 4 according to this embodiment will be described while referring to FIGS. 11 to 14 and the lens data given below.

In the objective lens 4 of this example, the first lens group G1 includes, in order from the sample X side, a meniscus lens L1 having a concave surface facing toward the sample X and a meniscus lens L2 having a concave surface facing toward the sample X. The second lens group G2 includes, in order from the sample X side, a meniscus lens L3 having a concave surface facing toward the sample X, a cemented lens including a meniscus lens L4 having a convex surface facing toward the sample X, a biconvex lens L5, and a meniscus lens L6, a

| Surface number | r | d | nd | νd |
|---|---|---|---|---|
| 1 | ∞ | 2.0000 | 1.4585 | 67.80 |
| 2 | ∞ | 2.0000 | | |
| 3 | −4.2500 | 0.4510 | 1.6030 | 65.44 |
| 4 | −13.4696 | 0.1020 | | |
| 5 | 79.6551 | 1.3837 | 1.7380 | 32.26 |
| 6 | −14.3032 | 0.1000 | | |
| 7 | 19.6305 | 1.8119 | 1.6730 | 38.15 |
| 8 | 7.7287 | 3.6934 | 1.4970 | 81.55 |
| 9 | −9.0783 | 0.1000 | | |
| 10 | 8.5912 | 0.3200 | 1.6730 | 38.15 |
| 11 | 4.7008 | 3.8178 | 1.4388 | 94.95 |
| 12 | −7.7520 | 0.3200 | 1.7380 | 32.26 |
| 13 | −20.0787 | 0.1000 | | |
| 14 | 4.2464 | 1.8881 | 1.4970 | 81.55 |
| 15 | 19.4995 | 0.1000 | | |
| 16 | 4.4083 | 0.7505 | 1.6779 | 55.34 |
| 17 | 6.1425 | 0.1000 | | |
| 18 | 3.4366 | 1.5381 | 1.8830 | 40.77 |
| 19 | 1.7500 | 0.9998 | | |

The focal length of the objective lens 4 is 4.5 mm, and the numerical aperture is 0.75.

In the above lens data, surface number 2 refers to a coded aperture, i.e., the phase plate 5, and the radius of curvature r is given as ∞, but the actual shape would be:

z=2.0×10⁻¹¹(x³+y³) (3).

The flat plate glass material is synthetic quartz or another glass material that exhibits low auto-fluorescence.

According to the lens data, the focal length of the objective lens 4 is f=4.5, the focal length of the first lens group G1 is f1=−16.88, the focal length of the second lens group G2 is f2=6.16, and the focal length of the third lens group G3 is f3=−10.45.

Therefore, f1/f=−3.75 and f3/f=−2.32, and conditional expressions (3) and (4) are satisfied.

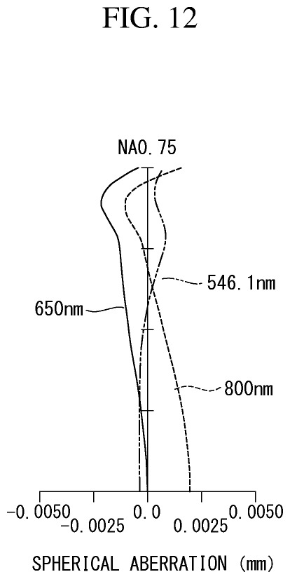

FIGS. 12 to 14 illustrate aberration diagrams. It is clear that aberrations are well corrected.

As a result, the above-described embodiment leads to the following aspect.

An aspect of the present invention is directed to a microscope objective lens including: in order from an object side, a first lens group having a negative refractive power; a second lens group having a positive refractive power; a third lens group having a negative refractive power; and a phase plate arranged nearer to an image side than a lens of the third lens group arranged nearest the image side is. A surface of the first lens group nearest the object side is a concave surface facing toward the object. The microscope objective lens satisfies the following conditional expression:

−3.8≤f1/f≤−2.0

Here, f is the local length of the microscope objective lens, and f1 is the focal length of the first lens group.

According to this aspect, by satisfying the conditional formula, the principal point on the image side can be positioned on the image side, the exit pupil can be arranged nearer to the image side than the third lens group is, and the phase plate can be arranged at a position aligned with the exit pupil. This makes it possible to perform positional adjustment of the phase plate outside of precisely configured lens groups without affecting the lens groups. When the phase plate is a coded aperture, the position of the phase plate can be easily and precisely adjusted.

Below the lower limit of the conditional expression, the refractive power of the first lens group is small, and the principal point cannot be sufficiently moved toward the image side. In addition, above the upper limit of the conditional expression, the refractive power of the first lens group is too high, aberration balance is degraded, and imaging performance deteriorates.

In the above-described aspect, the following conditional expression may be satisfied:

−5.0≤f3/f≤−2.3

Here, f3 is the focal length of the third lens group.

With this configuration, a sufficient operational distance can be secured.

Below the lower limit of the conditional expression, the refractive power of the third lens group is small, and it is difficult to ensure the working distance. In addition, above the upper limit of the conditional expression, the refractive power of the third lens group is too high, aberration balance is degraded, and imaging performance deteriorates.

In addition, in the above-described aspect, the phase plate may have a surface shape expressed by the following expression:

z=k(x³+y³)

Here, z is the coordinate in optical axis direction, x, y the coordinates in two directions perpendicular to the optical axis direction and perpendicular to each other, and k is an arbitrary rational number.

In addition, another aspect of the present invention provides a microscope including any of the above-described microscope objective lenses.

In the above-described aspect, the microscope may include the above-described microscope objective lens and an adjustment mechanism that adjusts shifting in Z-axis directions along an optical axis, shifting in X-axis directions perpendicular to the Z axis, and shifting in Y-axis directions perpendicular to the Z axis and the X axis, and adjusts a rotational angle around the Z axis.

In addition, in the above-described aspect, the microscope may further include: a light source that generates excitation light; an image-forming lens that images fluorescence that has passed through the microscope objective lens; an image-capturing element that subjects the image formed by the image-forming lens to electro-optical conversion; and a microlens array that is arranged between the image-forming lens and the image-capturing element.

The present invention affords the advantage that precise positional adjustment of a phase plate can be easily performed.

### REFERENCE SIGNS LIST

1 microscope
3 light source
4 objective lens (microscope objective lens)
5 phase plate
6 image-forming lens
7 image-capturing element
9 microlens array
G1 first lens group
G2 second lens group
G3 third lens group
L9, L10, L12 meniscus lens (lens)
X sample (object)

1. A microscope objective lens comprising:
in order from an object side, a first lens group having a negative refractive power;
a second lens group having a positive refractive power;
a third lens group having a negative refractive power; and
a phase plate arranged nearer to an image side than a lens of the third lens group arranged nearest the image side is,
wherein a surface of the first lens group nearest the object side is a concave surface facing toward the object, and
the following conditional expression is satisfied:
−3.8≤f1/f≤−2.0
where
f: focal length of the microscope objective lens, and
f1: focal length of the first lens group.

2. The microscope objective lens according to claim 1, wherein the following conditional expression is satisfied:
−5.0≤f3/f≤−2.3
where
f3: focal length of the third lens group.

3. The microscope objective lens according to claim 1, wherein the phase plate has a surface shape expressed by the following expression:
z=k(x³+y³)
where
z: coordinate in optical axis direction,
x, y: coordinates in two directions perpendicular to optical axis direction and perpendicular to each other, and
k: arbitrary rational number.

4. A microscope comprising:
the microscope objective lens according to claim 1; and
an adjustment mechanism that adjusts shifting in Z-axis directions along an optical axis, shifting in X-axis directions perpendicular to the Z axis, and shifting in Y-axis directions perpendicular to the Z axis and the X axis, and adjusts a rotational angle around the Z axis.

5. The microscope according to claim 4, further comprising:
a light source that generates excitation light;
an image-forming lens that forms fluorescence that has passed through the microscope objective lens into an image;
an image-capturing element that subjects the image formed by the image-forming lens to electro-optical conversion; and
a microlens array that is arranged between the image-forming lens and the image-capturing element.
